(19) United States
(12) Patent Application Publication
(10) Pub. No.: US 2026/0242073 A1
(43) Pub. Date: Aug. 20, 2026

(54) TRANS-DOMAIN AUTONOMOUS VEHICLE (TDAV) BUOYANCY SYSTEM AND METHOD THEREOF

(71) Applicant: THE UNITED STATES OF AMERICA, AS REPRESENTED BY THE SECRETARY OF THE NAVY, Arlington, VA (US)

(72) Inventor: Ross Anthony Eldred, Salinas, CA (US)

(21) Appl. No.: 19/056,955

(22) Filed: Feb. 19, 2025

(51) Int. Cl. B64U 10/70; B60F 5/02; B63G 8/00; B63G 8/24; B64U 10/30

(52) U.S. Cl. CPC B64U 10/70; B60F 5/02; B63G 8/001; B63G 8/24; B64U 10/30

(57) ABSTRACT

A trans-domain autonomous vehicle buoyancy control apparatus comprising: an autonomous vehicle; one or more expansion volumes; a cryogen gas; and a chemical gas; wherein the autonomous vehicle is configured to submerge through a fluid column and ascend through a fluid and gas column; wherein the one or more expansion volumes is configured to accept the cryogen gas; wherein the buoyancy of the autonomous vehicle within the fluid column is controlled by the cryogen gas; wherein the one or more expansion volumes is configured to accept the chemical gas; and wherein the buoyancy of the autonomous vehicle within the gas column is controlled by the cryogen and chemical gas.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to an autonomous vehicle buoyancy system and method. More specifically, the present disclosure relates a system and method of controlling the buoyancy of a trans-domain autonomous vehicle.

### BACKGROUND

Generally, 3-dimensional navigation is restricted by the boundaries of each domain, such as sea and air. Although each domain can be generalized as a fluid and a vehicle analyzed as navigating through a fluid, each domain has different fluid properties that place different constraints and demands on a vehicle as it navigates through a fluid.

Typically, autonomous vehicles are designed for a specific task within a single domain or medium of operation. Tasks include package delivery, aerial photography, surveillance, weapons delivery, communications, and dropping leaflets and decoys. Underwater vehicles are typically designed to withstand externally applied pressures, buoyance control, and 3-dimension propulsion. Aerial vehicles may be designed as a fixed wing, rotary wing, or a combination called vertical take-off and landing (VTOL) and are designed to be lightweight but require continuous propulsion as buoyancy is not typically varied to control flight.

The tasks performed by each of the different designed vehicles do not vary significantly between domains. This results in systems that are not only inefficient but also costly, with duplicative sensors and vehicles being used to perform the same tasks in different domains.

Therefore, what is needed is an autonomous vehicle capable of navigating and performing tasks in more than one domain or medium.

### INCORPORATION BY REFERENCE

The following publications are incorporated by reference in their entirety.

U.S. Pat. No. 12,032,373, issued on Jul. 9, 2024, by Ross Anthony Eldred.

U.S. Patent Application Publication No. US2023/0182876, published on Jun. 15, 2023, by Ross Anthony Eldred.

### SUMMARY

To minimize the limitations in the prior art and to minimize other limitations that will become apparent upon reading and understanding the present specification, the present disclosure discloses a new and useful trans-domain autonomous vehicle.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem of requiring multiple autonomous vehicles to perform similar tasks in multiple domains or mediums is solved by a single trans-domain autonomous vehicle utilizing a buoyancy control system and method thereof.

A trans-domain autonomous vehicle may navigate from a gas column through and to the bottom of a fluid column and return to the fluid and gas column's boundary to navigate through altitudes of the gas column by controlling its internal pressure and buoyancy. The trans-domain autonomous vehicle may control its buoyancy by varying its mass and or volume. The internal pressure of the trans-domain autonomous vehicle may counteract the external pressure against the trans-domain autonomous vehicle, thereby allowing for a more buoyant vehicle.

A trans-domain autonomous vehicle may include a deployable balloon, a pressure equalization outlet, an expansion volume, an electrolysis gas generator outlet, multiple tunnel thruster outlets, a fill port, energy cells, an electrolysis gas generator, a heat exchanger, heat exchanger inlet, a cryogen input valve, cryogen, internal pressure relief valve, and cryo-hull. A trans-domain autonomous vehicle may control its internal pressure and volume. The volume of a trans-domain autonomous vehicle relates to its buoyancy and payload while ascending from a liquid fluid environment into a gaseous fluid environment. The heavier a trans-domain autonomous vehicle becomes, the greater the volume the trans-domain autonomous vehicle will be required to displace to ascend through the fluid.

One embodiment of a trans-domain autonomous vehicle buoyancy control apparatus comprising: a vehicle; expansion volumes; a cryogen gas; an electrolysis gas and a chemical gas; wherein the vehicle may be configured to ascend and descend through a fluid column; wherein the expansion volumes may be configured to accept the liquid cryogen gas; wherein a buoyancy of the vehicle within the fluid column may be controlled by the cryogen gas; wherein the expansion volumes may be configured to accept the chemical gas; and wherein the buoyancy of the vehicle within a gas fluid column may be controlled by the chemical gas. Wherein the expansion volumes for cryogen gas and the expansion volumes for chemical gas may be different expansion volumes. Wherein the expansion volumes may be a balloon. Wherein the balloon may be configured to expand outside the vehicle hull. A trans-domain autonomous vehicle may further comprise: energy cells; controllers; and a cryo-hull; where the energy cells may be configured to provide electrical energy to the vehicle; wherein the controllers may be configured to accept a mission profile and maintain a self-preservation profile; and wherein the cryo-hull may be configured to store cryogen. Wherein the cryo-hull may be configured to jettison panels. A trans-domain autonomous vehicle may further comprise ballast chambers; wherein the ballast chambers may be configured to retain a ballast configured to be jettisoned. A trans-domain autonomous vehicle may further comprise pressure sensors; wherein the pressure sensors may be configured to measure internal and external pressures of the vehicle. A trans-domain autonomous vehicle may further comprise a relief valve, wherein the relief valve may be configured to regulate internal gas pressure. Wherein an internal pressure regulates the buoyancy within a fluid column pressure; wherein internal pressure may be controlled by a plurality of valves configured to release the cryogen gas; wherein the cryogen gas expands and wherein the expanded cryogen gas increases the internal pressure of the vehicle; wherein an increase in internal pressure of the vehicle increases buoyancy; wherein the cryogen gas may be released by the plurality of valves and wherein the release of the cryogen gas decreases the internal pressure; wherein a decrease in internal pressure of the vehicle decreases buoyancy; and wherein the vehicle buoyancy may be neutrally maintained by the plurality of valves. A trans-domain autonomous vehicle may further comprise a chemical gas generator, wherein the chemical gas generator produces a gas from a chemical reaction; and wherein the chemical reaction may be between a calcium disc and seawater.

In an alternative embodiment of a method for controlling the buoyancy of a trans-domain autonomous vehicle, the method comprising: by a trans-domain autonomous vehicle within a fluid medium; descending, by the trans-domain autonomous vehicle, through medium, where as a buoyant force acting on the trans-domain autonomous vehicle may be less than a gravitational force acting on the trans-domain autonomous vehicle; equalizing, by a gas, whereas the gas expands into expansion volumes, whereas the expansion of the gas equalizes any difference between an external pressure and an internal pressure of the trans-domain autonomous vehicle; neutralizing, by the gas into expansion volumes, whereas the buoyant force acting on the trans-domain autonomous vehicle equals gravitational force acting on the trans-domain autonomous vehicle at a desired depth within the fluid medium; and ascending, by a gas, whereas the gas expands into expansion volumes; whereas the buoyant force acting on the trans-domain autonomous vehicle may be greater than the gravitational force acting on the trans-domain autonomous vehicle within the fluid medium. The method further including: reducing buoyance, by retaining ballasts on the trans-domain autonomous vehicle. The method further including: reducing a cryo-hull thickness, whereas the equalization of the internal pressure of the trans-domain autonomous vehicle to the external fluid medium strengthens a reduced thickness cryo-hull. The method further including: fast ascension, by releasing the ballasts retained by the trans-domain autonomous vehicle, whereas the release of the ballasts increases buoyancy and rate of ascension. The method further including: electrolysis boosting, by electrolysis gas generators, by generating hydrogen and oxygen gas, whereas the hydrogen and oxygen gas expands into expansion volumes. The method whereas the expansion volumes may be balloons.

A Seabed-To-Atmosphere Robot comprising: an autonomous vehicle; expansion volumes; a cryogen gas; a chemical gas; energy cells; controllers; and a cryo-hull; where the energy cells may be configured to provide electrical energy to the autonomous vehicle; wherein the controllers may be configured to accept a mission profile and maintain a self-preservation profile; wherein the cryo-hull may be configured to store cryogen; wherein the autonomous vehicle may be configured to submerge through a fluid column and ascend through a fluid and a gas column; wherein the expansion volumes may be configured to accept the cryogen gas; wherein the buoyancy of the autonomous vehicle within the fluid column may be controlled by the cryogen gas; wherein the expansion volumes may be configured to accept the chemical gas; wherein the buoyancy of the autonomous vehicle within the gas column may be controlled by the chemical gas; wherein internal pressure may be controlled by a plurality of valves configured to release the cryogen gas; wherein the cryogen gas expands and where the expanded cryogen gas increases the internal pressure of the autonomous vehicle; wherein an increase in internal pressure of the autonomous vehicle increases buoyancy; wherein the cryogen gas may be released by the plurality of valves and wherein the release of the cryogen gas decreases the internal pressure; wherein a decrease in internal pressure of the autonomous vehicle decreases buoyancy; and wherein the autonomous vehicle buoyancy may be neutrally maintained by the plurality of valves. The apparatus wherein the expansion volumes for cryogen gas and the expansion volumes for chemical gas may be different expansion volumes. The apparatus further comprising a chemical gas generator; wherein the chemical gas generator produces hydrogen gas from a chemical reaction.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIGS. 1A-1B are cross-sectional views of one embodiment of a trans-domain autonomous vehicle.

FIG. 2 is a cross-section perspective view of one embodiment of a trans-domain autonomous vehicle configured for buoyant ascent via balloon inflation.

FIG. 3 is a graph illustrating the lifting capacity of different cryogen gases.

FIG. 4 is a process flow block diagram of one embodiment of a method for controlling the buoyancy of a trans-domain autonomous vehicle.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “autonomous vehicle” refers to a craft or vessel that can be operated remotely or autonomously without a human pilot or passengers.

As used herein, the term “buoyancy” refers to the upward force exerted on an object partially or fully immersed in a fluid.

As used herein, the term “chemical gas” refers to any gas created by a chemical reaction.

As used herein, the term “cryogen” refers to a liquid having very low temperatures.

As used herein, the term “cryogen gas” refers to a gas converted from a cryogen liquid.

As used herein, the terms “domain” and “medium” refer to the ambient environment substance or material a wave travels through, such as a liquid or a gas.

As used herein, the term “fluid” refers to substances that flow easily because of increased intermolecular spaces and do not have a fixed shape.

As used herein, the term “flight plan” or “mission plan” refers to a planned navigation route that includes the weight, fuel, payload, range, speed, flight altitude, loiter, and any other operations that a vehicle must complete.

As used herein, the term “navigating” or “navigation” refers to the act of traveling through a medium.

As used herein, “vehicle” or “trans-domain autonomous vehicle” refers to a vessel or craft that travels through both a liquid and gas medium.

Vehicles typically navigate in a single medium using multiple forces, such as but not limited to gravity, buoyancy, and thrust. For example, a vessel may use a propulsion system to thrust itself through a liquid medium combined with gravity and buoyancy to control depth. Likewise, an aircraft may propel itself through a gas medium, creating lift combined with gravity to control altitude.

A trans-domain autonomous vehicle may navigate through both a liquid and gas medium by controlling its buoyancy. A trans-domain autonomous vehicle may be a completely autonomous vehicle capable of being programmed to complete a mission plan or remotely controlled by an operator at a distance. A trans-domain autonomous vehicle may control its buoyancy through various methods, including but not limited to changing its volume.

Molecules in a liquid may be more compact than in gases, and most liquids may be converted to gas. This property may be controlled to manage the volume of an object or vehicle.

Buoyancy may be the upward force exerted on an object partially or fully immersed in a fluid. The buoyant force on an object may equal to the weight of the ambient fluid displaced by the object, which may be the density of the fluid multiplied by the submerged volume times the gravitational acceleration. An object may be positively buoyant when its weight may be less than the fluid it displaces. Where the weight of an object may not vary significantly to increase or control buoyancy, its volume can be changed significantly. Increasing the volume of an object or vehicle can significantly displace more fluid weight, thereby increasing buoyancy. Alternatively, gas may be purged to reduce volume, thereby reducing the buoyancy of an object or vehicle.

The mass may be controlled by jettisoning weights, fluid, or any other unnecessary component in or on the trans-domain autonomous vehicle.

Total volume may be controlled by expansion volumes capable of ambient fluid displacement.

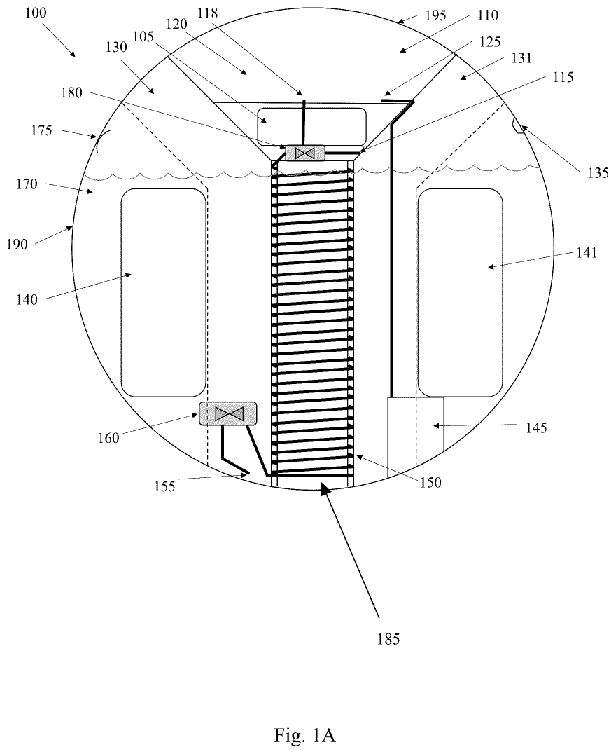

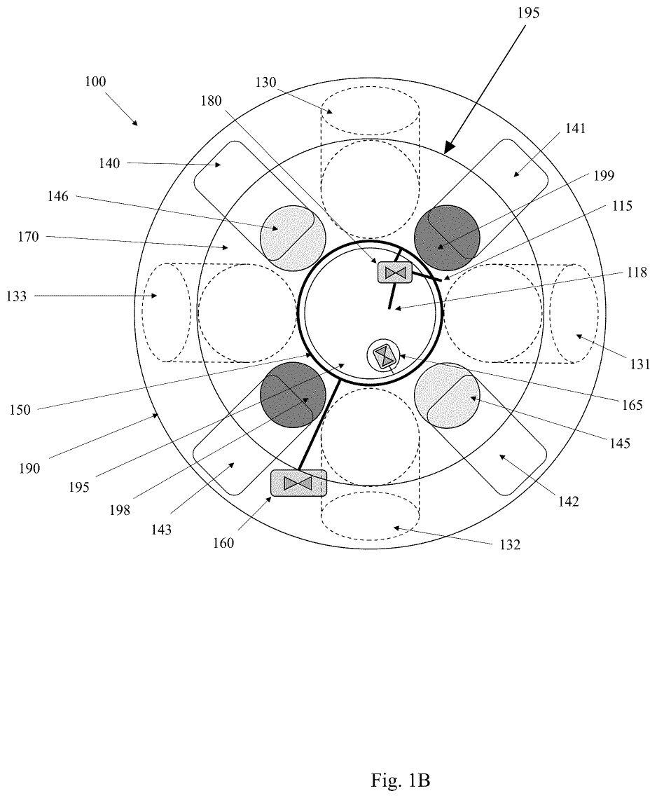

FIGS. 1A-1B are cross-sectional views of one embodiment of a trans-domain autonomous vehicle.

As shown in FIG. 1A and FIG. 1B, trans-domain autonomous vehicle 100 may include one or more controller 105, deployable balloon 110, at least one pressure equalization outlet 115, at least one gas capture outlet 118, one or more expansion volumes 120, electrolysis gas generator outlet 125, one or more tunnel thrusters 130, 131, 132, and 133 fill port 135, one or more energy cells 140, 141, 142, and 143, electrolysis gas generator 145 and 146, heat exchanger 150, heat exchanger inlet 155, heat exchanger valve 160, chemical gas generator 165, cryogen 170, internal pressure relief valve 175, one pressure equalization/gas capture valve 180, one central payload tube 185, one cryo-hull 190, one or more ejection panels 195, and one or more ballast chambers 198 and 199.

Referring to FIG. 1A, cryogen 170 may typically have high liquid-to-gas expansion ratios and boiling points below minus 130 degrees F. (minus 90 degrees C.). Cryogen 170 may include but should not limited to acetylene, argon, air, carbon monoxide, diborane, ethylene, helium, hydrogen, hydrogen cyanide, hydrogen fluoride, methane, neon, and nitrogen.

As shown in Table 1, different cryogen 170 liquids may have different lifting characteristics, which may be determined by the expansion ratio of a specified volume of cryogen 170.

TABLE 1
36-inch spherical trans-domain lifting characteristics of cryogen liquid.

| | | | | | | Lift in |
|---|---|---|---|---|---|---|
| | Total | | | | | air @ |
| | Volume | Practical | Expansion | Density | Weight | Sea |
| | Spherical | Volume | Ratio | Lifting Gas | Lifting Gas | Level |
| Cryogen | Hull (ft\hat{ }3) | (2/3) (ft\hat{ }3) | (gas/liquid) | (lb./ft\hat{ }3) | (lb.) | (lb.) |
| H2 | 14.137 | 9.425 | 865 | 0.006 | 45.703 | 577.96 |
| He | 14.137 | 9.425 | 780 | 0.011 | 81.965 | 480.41 |
| NH3 | 14.137 | 9.425 | 850 | 0.047 | 380.086 | 232.56 |
| CH4 | 14.137 | 9.425 | 650 | 0.045 | 275.357 | 193.29 |
| Ne | 14.137 | 9.425 | 1445 | 0.056 | 766.024 | 275.81 |
| N2 | 14.137 | 9.425 | 710 | 0.074 | 498.443 | 13.46 |

TABLE 2
72-inch spherical trans-domain lifting characteristics of cryogen liquid.

| | | | | | | Lift in |
|---|---|---|---|---|---|---|
| | Total | | | | | air @ |
| | Volume | Practical | Expansion | Density | Weight | Sea |
| | Spherical | Volume | Ratio | Lifting Gas | Lifting Gas | Level |
| Cryogen | Hull (ft\hat{ }3) | (2/3) (ft\hat{ }3) | (gas/liquid) | (lb./ft\hat{ }3) | (lb.) | (lb.) |
| H2 | 113.097 | 75.398 | 865 | 0.006 | 365.622 | 4623.67 |
| He | 113.097 | 75.398 | 780 | 0.011 | 655.716 | 3843.29 |
| NH3 | 113.097 | 75.398 | 850 | 0.047 | 3040.692 | 1862.07 |
| CH4 | 113.097 | 75.398 | 650 | 0.045 | 2202.854 | 1546.32 |
| Ne | 113.097 | 75.398 | 1445 | 0.056 | 6128.194 | 2206.51 |
| N2 | 113.097 | 75.398 | 710 | 0.074 | 3987.546 | 107.71 |

As represented in Tables 1 and 2, the expansion ratio may impact the resulting buoyant force for a given volume of cryogen.

Because of the density difference between water and gases (water being approximately 1,000 times denser than most gases), the lifting potential of stored underwater gases may be significant.

In order to produce lift, cryogen 170 should preferably convert to a gas lighter than the surrounding (ambient) fluid in which the trans-domain autonomous vehicle 100 may be submerged. To continue to provide lift above a liquid surface (in an atmosphere of air), a lighter-than-air, cryogen 170 should be chosen. Examples of cryogens 170 lighter-than-air may include but should not be limited to: hydrogen, helium, ammonia, methane, and neon.

Referring to FIG. 1B, chemical gas generator 165 may include a reaction by one or more chemicals to produce a gas, such as a gas evolution reaction. Chemical reactions may include but should not be limited to baking soda and vinegar to create carbon dioxide gas; zinc and dilute sulfuric acid to create hydrogen gas; nitric acid and sodium carbonate to create carbon dioxide; dilute hydrochloric acid and sodium carbonate to create carbon dioxide, and calcium discs with seawater to create hydrogen gas.

Referring to FIGS. 1A and 1B, electrolysis gas generators 145 and 146 may utilize an electrolysis process utilizing an electric current to convert water into hydrogen and oxygen gas. An electric current may be applied across electrolytes in electrolysis gas generators 145 and 146 during electrolysis. An anode, (not shown) within electrolysis gas generators 145 and 146 may attract negatively charged hydroxide ions, releasing oxygen gas, while a cathode (not shown), within electrolysis generators 145 and 146, may attract positively charged hydrogen ions, releasing hydrogen gas. The amount of hydrogen produced may be double the amount of oxygen, and both may be proportional to the total electrical charge conducted by the solution. The produced gases may be used to control the trans-domain autonomous vehicle 100 buoyancy. Electrolysis gas generator outlet 125 may release generated gases into deployable balloon 110 or one or more expansion volumes 120.

Referring to FIG. 1A, pressure equalization outlet 115 may be an outlet from a valve or tube that releases expanding gas converted from cryogen 170. Pressure equalization outlet 115 may be but should not be limited to a valve controlled by controller 105 to release expanding gas into one or more expansion volumes 120. The expanding gas may increase internal pressure of trans-domain autonomous vehicle 100 until the internal pressure of trans-domain autonomous vehicle 100 may be equal to the external (ambient) pressure. Pressure equalization may allow materials used to construct cryo-hull 190 to be thinner and lighter. Trans-domain autonomous vehicle 100 may also include internal pressure relief valve 175 that may relieve excessive internal pressure. Internal pressure relief valve 175 may be an automatic mechanical pressure relief valve or may be controlled by controller 105.

Ballon 110 may be but should not be limited to a balloon platform that may be deployed from the depths of the sea floor to altitudes extending to the upper atmosphere. Balloon 110 may carry trans-domain autonomous vehicle 100 and a payload (not shown) from submerged depths to ascending altitudes to a specific target or target area. Balloon 110 may preferably be stored within trans-domain autonomous vehicle 100 until additional volume for generating buoyancy may be needed. Trans-domain autonomous vehicle 100 may preferably be capable of continuous volume control from the seabed through the upper atmosphere.

As submerged pressure vessel, containing a compressed gas, rises the compressed gas may expand and may cause the submerged pressure vessel to explode due to an excessive increase in internal pressure unless sufficient gas may be able to escape during the ascent or the enclosure, such as balloon 110 or cryo-hull 190, or the submerged pressure vessel may be sufficiently and structurally capable of withstanding the change in pressure. Internal pressure relief valve 175 may provide this relief within cryo-hull 190 and the pressure equalization outlet 115 may provide this relief within the balloon.

Multiple tunnel thrusters 130, 131, 132, and 133, may be positioned to accommodate an internal propulsion system.

Referring to FIG. 1A, fill port 135 may accept cryogen 170 liquid or gas as mission or flight plans demand.

Referring to FIG. 1B, energy cells 140, 141, 142 and 143, may include, but should not be limited to, supercapacitors, electrochemical batteries, Peltier devices, or any other method of storing or producing energy to operation systems or components on or within trans-domain autonomous vehicle 100.

Heat exchanger 150 may be a device that transfers heat from one medium to another. Heat exchanger 150 may preferably transfer heat to the cryogen 170. Heat exchanger inlet 155 may be a tube inlet extending from the heat exchanger 150 to the lowest point of the cryo-hull 190 that may enable cryogen 170 to enter the heat changer 150 coil. Controller 105 may control the flow of cryogen 170 into the heat exchanger 150 via heat exchanger valve 160. With heat exchanger valve 160 open, positive pressure within cryo-hull 190 may cause cryogen 170 to enter the heat exchanger 150. Controller 105 may determine the destination of the expanded cryogenic gas exiting heat exchanger 150 via pressure equalization/gas capture valve 180. Pressure equalization/gas capture valve 180 may when set to “pressure equalization” position, allow expanded gas to be directed back into cryo-hull 190 via pressure equalization outlet 115. Pressure equalization/gas capture valve 180 may when set to a “gas capture” position, allow gas to be delivered to balloon 110 via gas capture outlet 118. Heat may be transferred from a heat source (not shown) such as but not limited to the ambient environment or another heat source to cryogen 170 inside heat exchanger 150 via thermal conduction through walls of heat exchanger 150 coil, which may be exposed to the sea or ambient environment within a central, vertical cavity of cryo-hull 190. Phase change from cryogenic 170 liquid to gas may occur within the coil of heat exchanger 150.

One or more expansion volumes 120 may be voids within the trans-domain autonomous vehicle 100. Expansion volumes 120 may be thermally isolated from cryo-hull 190 and systems and components of trans-domain autonomous vehicle 100.

Cryo-hull 190 may preferably be constructed to support various internal structures, features, and accessories. Cryo-hull 190 may be configured to allow the filling of cryogen 170 and may allow internal gases to vent or escape without compromising the structure of cryo-hull 190. Cryo-hull 190 may preferably be constructed using lightweight and strong materials, such as but not limited to composites, thin steel, and aluminum, but may also be made from any suitable material that provides strength and sufficiently insulative. Internal pressure control may increase the strength of lightweight and thin materials thus resisting ambient pressure at increased operating depths.

Controller 105 may be an embedded microcontroller or system-on-a-chip capable of receiving data from one or more sensors, controlling one or more systems on a vehicle, communicating with remote systems, accepting remote commands, and preferably reprogrammable.

Ejection panel 195 may be a panel removably attached to trans-domain autonomous vehicle 200. Ejection panel 195 may be jettisoned from trans-domain autonomous vehicle 100

Ballast chambers 198 and 199 may be voids configured to accept releasable ballast (weights) to increase the total weight of the trans-domain autonomous vehicle 100. Ballast chambers 198 and 199 may preferably be configured to optionally jettison ballast as trans-domain autonomous vehicle 100 may be commanded to ascend through an ambient fluid. By jettisoning ballast, the ascension of the trans domain autonomous vehicle 200 may be expedited.

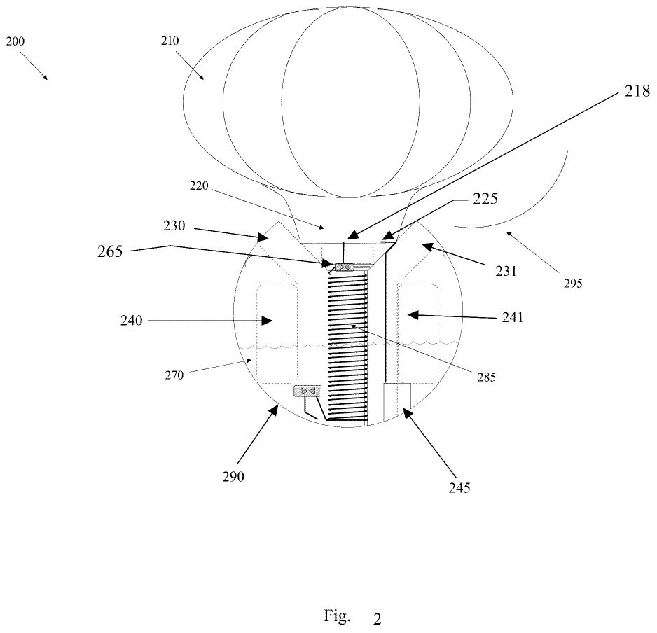

FIG. 2 is a cross-section perspective view of one embodiment of a trans-domain autonomous vehicle configured for buoyant ascent via balloon inflation. Trans-domain autonomous vehicle 200 may include deployable balloon 210, ejection panel 295, expansion volume 220, and center payload chamber 285. Expansion volume 220 which may be but should not be limited to a balloon, inflated with a gas expanded from liquid cryogen 170, as shown in FIG. 1A.

Ballon 210 may be deployable and preferably constructed using lightweight and strong materials, such as but not limited to Hypalon®, nylon, polyvinyl chloride (PVC) coated nylon, PVC-tarpaulin, polyurethane, and drop stitch, but may be made from any sufficiently strong and lightweight material. Balloon 210 may preferably be affixed to trans-domain autonomous vehicle 200 structure with sufficient integrity to prevent gas leakage and sufficient strength to lift all or some portion of the vehicle 200 in addition to any potential payload carried by central payload tube 285. Central payload tube 285 may be located within a space inside heat exchanger coil 250. Both heat exchanger coil 250 and central payload tube 285 may be external to the cryo-hull 290 and may preferably aligned with the central, vertical axis of vehicle 200.

Ejection panel 295 may be a panel removably attached to trans-domain autonomous vehicle 200. Ejection panel 295 may be jettisoned from trans-domain autonomous vehicle 200 by the expansion of a gas in balloon 210 via the gas capture outlet 218 and/or the activation of the chemical gas generator 265 delivering gas via electrolysis gas generator outlet 225, or via the activation of the chemical gas generator 265.

Tunnel thrusters 230 and 231 may be positioned to accommodate an internal propulsion system.

Expansion volume 220 may be thermally isolated by Cryo-hull 290 as shown in FIG. 2. Expansion volume 220 may preferably be constructed to withstand pressures of converted cryogenic liquid 270 as it expands into a gas. Expansion volume 220 may be but should not be limited to a void within trans-domain autonomous vehicle 200.

Energy cells 240 and 241 may include but should not be limited to supercapacitors, electrochemical batteries, Peltier devices, or any other method of storing or producing energy for operation of systems or components on or within trans-domain autonomous vehicle 200. Trans-domain battery 240 and 241 may preferably be capable of operating all electronic systems, subsystems, and components.

Electrolysis gas generator 245 may utilize the electrolysis process that uses an electric current to convert water into hydrogen and oxygen gas. An electric current may be applied across electrolytes in electrolysis gas generator 245 during electrolysis. An anode (not shown) within electrolysis gas generator 245 may attract negatively charged hydroxide ions, releasing oxygen gas, while a cathode (not shown), within the electrolysis gas generator 245, may attract positively charged hydrogen ions, releasing hydrogen gas. In ideal conditions, the amount of hydrogen produced may double the amount of oxygen, and both may be proportional to the total electrical charge conducted by the solution. The produced gases may be used to control the trans-domain autonomous vehicle 200 buoyancy.

Central payload tube 285 may be a void in the center of the trans-domain autonomous vehicle 200. Central payload tube 285 may be swappable and configurable, depending on mission-specific configurations for various effects delivery or persistent presence missions and may preferably be aligned with the vertical axis of the trans domain autonomous vehicle 200.

Chemical gas generator 265 may incorporate the reaction of one or more chemicals to produce gas, such as but not limited to a gas evolution reaction. Chemical reactions include but should not be limited to baking soda and vinegar that may create a carbon dioxide gas; zinc and dilute sulfuric acid that may create hydrogen gas; nitric acid and sodium carbonate that may create carbon dioxide; dilute hydrochloric acid and sodium carbonate that may create carbon dioxide, and calcium discs with sea water that may create hydrogen gas. Chemical gas generator 265 may be used to provide some or all of the gas required to expand deployable balloon 210 and cause ejection panel 295 to eject, thus expediting balloon 210 expansion and minimizing the time required for the trans-domain autonomous vehicle's 200 initial ascent.

Energy cells 240 and 241 may include but should not be limited to supercapacitors, electrochemical batteries, Peltier devices, or any other method of storing or producing energy to operation systems or components on or within trans-domain autonomous vehicle 200.

Cryo-hull 290 may be thermally insulated to retain cryogenic liquid 270. Expansion volume 220 may preferably be constructed to withstand elevated pressures resulting from conversion of cryogenic liquid 270 to gas. Expansion volume 220 may be any void within trans-domain autonomous vehicle 200.

Tunnel thrusters 230 and 231 may be positioned, as required, to accommodate an internal propulsion system.

Controller 205 may be an embedded microcontroller or system-on-a-chip capable of receiving data from one or more sensors, controlling one or more systems on a vehicle, communicating with remote systems, accepting remote commands, and may preferably be reprogrammable.

Balloon 210 may function as an expansion volume. Balloon 210 may be stowed under ejection panel 295 prior to expansion. Balloon 210 may preferably be configured to accept expanding gas to overcome the external ambient fluid pressure to jettison ejection panel 295 and allow the balloon 210 to expand outside of the trans-domain autonomous vehicle 200.

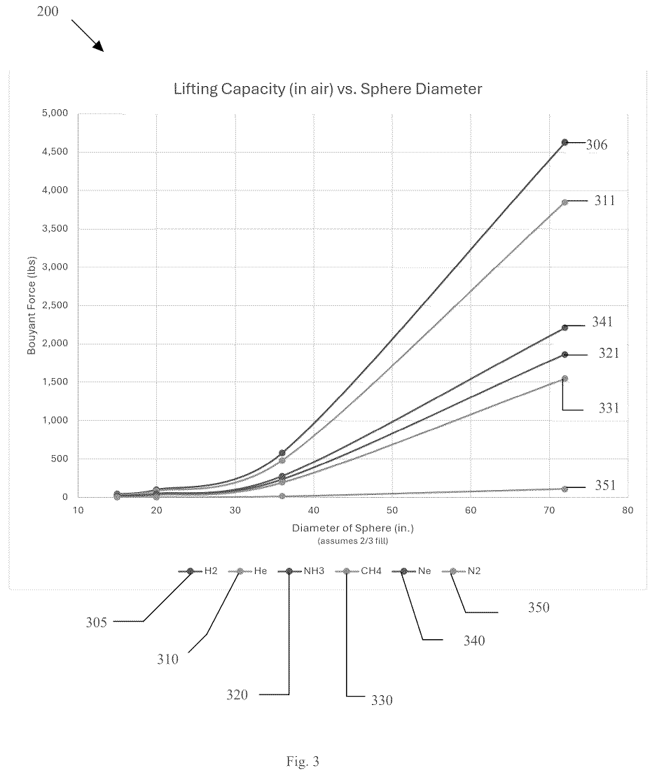

FIG. 3 is a graph illustrating the lifting capacity of different cryogen gases. Lifting capacity of hydrogen 305 based on the size of a sphere may be represented by lifting line 306. Lifting capacity of helium 310 based on the size of a sphere may be represented by lifting line 311. Lifting capacity of ammonia 320 based on the size of a sphere may be represented by lifting line 321. Lifting capacity of methane 330 based on the size of a sphere may be represented by lifting line 331. Lifting capacity of neon 340 based on the size of a sphere may be represented by lifting line 341. Lifting capacity of nitrogen 350 based on the size of a sphere may be represented by lifting line 351. Although some cryogens may be great lifting gases, associated risks of flammability, toxicity, stability and asphyxiation must be taken into account. Table 3 shows lifting capacity of a spherical cryogen vehicle based on diameter, assuming the sphere may be ⅔ full of the respective liquid cryogen.

TABLE 3
Gas lifting capacity

| Vehicle Dia | Lifting Capacity (lb.) in air at surface | | | | | |
|---|---|---|---|---|---|---|
| (in) | H2 | He | NH3 | CH4 | Ne | N2 |
| 15 | 41.81 | 34.75 | 16.84 | 13.98 | 19.95 | 0.97 |
| 20 | 99.10 | 82.37 | 39.91 | 33.14 | 47.29 | 2.31 |
| 36 | 577.96 | 480.41 | 232.76 | 193.29 | 275.81 | 13.46 |
| 72 | 4,623.66 | 3,843.29 | 1,862.07 | 1,546.32 | 2,206.51 | 107.71 |

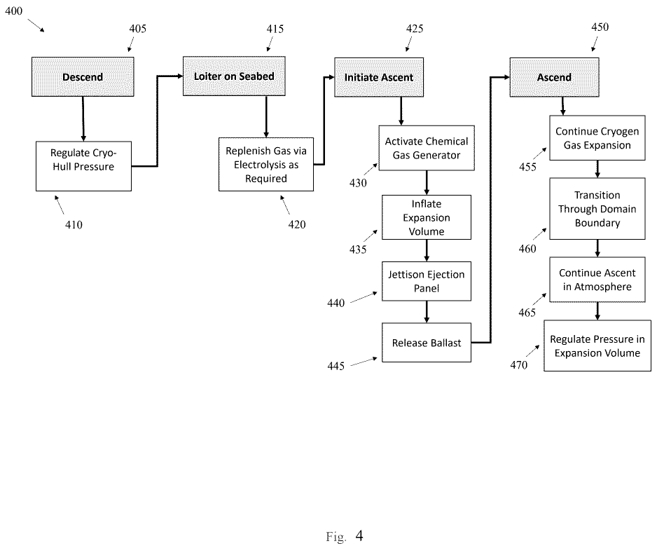

FIG. 4 is a process flow block diagram of one embodiment of a method for controlling the buoyancy of a trans-domain autonomous vehicle. As shown in FIG. 4, method 400 may comprise the following steps: descend 405; loiter on seabed 415; initiate ascent 425; and ascend 450. The vehicle may be positive, negative, or neutrally buoyant based at least in part on a relationship between the forces of buoyancy and the vehicle's weight. The buoyant force may be proportional to the volume of fluid displaced by the vehicle, while the weight force may be proportional to the mass of the vehicle. If the vehicle's weight exceeds the buoyant force, it may be negatively buoyant and descend in a fluid medium. During descend 405, the vehicle may regulate cryo-hull pressure 410 to counteract increasing pressure of the fluid medium as depth increases. A pressure differential across the hull may exist if internal pressure of the hull differs from the external pressure acting on the hull by the fluid. The vehicle may regulate pressure differentially by increasing or decreasing pressure within the hull. Internal pressure may be increased via phase-change expansion of cryogenic liquid into gas via the heat exchanger coil, or by gas from the electrolysis gas generator. Internal pressure may be decreased by off-gassing (ventilation) through the pressure relief valve. The vehicle may rest on a solid surface, such as but not limited to the seabed. Loiter on seabed 415 may include the vehicle loitering on or above the seabed, during which time the vehicle may replenish gas within the cryo-hull or one or more expansion volumes by replenishing gas generated via electrolysis as required 420. Initiate ascent 425, may include activating chemical gas generator 430 to inflate one or more expansion volumes, such as but not limited to a balloon. Inflate expansion volume 435, may also include jettison ejection panel 440 to accommodate the expansion. Additionally, release ballast 445 may cause addition ballast or weight to be released or expelled causing an upward acceleration. Ascend 450 may continue cryogen gas expansion 455 which may include directing cryogen into one or more expansion volumes. Once meeting a net positive buoyancy, the vehicle may ascend through the fluid medium to reaching a less dense medium boundary (i.e., reach the surface of the sea), if sufficiently buoyant, the vehicle may transition through domain boundary 460 and continue ascent in atmosphere 465. At any point during ascend 450, the vehicle may regulate pressure in expansion volume 470 to attain a desired depth or altitude, in either fluid medium, by attaining the desired net buoyancy via gas generation or off-gassing. The process of altitude and/or depth changes may continuously repeat indefinitely, so long as gas-generation capability may be retained.

In another embodiment multiple expansion volumes may be incorporated, enabling travel between domain boundaries multiple times. For example, the inflated balloon would be jettisoned near the surface of the fluid and the next expansion volume would provide the buoyant lift capability for the subsequent ascension through the liquid surface into the gaseous medium.

Equalizing internal pressure may allow for a reduced cryo-hull thickness as the internal pressure reduces the required structural strength.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A trans-domain autonomous vehicle buoyancy control apparatus comprising:
a vehicle;
one or more expansion volumes;
a cryogen gas;
an electrolysis gas and a chemical gas;
wherein the vehicle is configured to ascend and descend through a fluid column;
wherein the one or more expansion volumes are configured to accept the liquid cryogen gas;
wherein a buoyancy of the vehicle within the fluid column is controlled by the cryogen gas;
wherein the one or more expansion volumes is configured to accept the chemical gas; and
wherein the buoyancy of the vehicle within a gas fluid column is controlled by the chemical gas.

2. The apparatus of claim 1, wherein the one or more expansion volumes for cryogen gas and the one or more expansion volumes for chemical gas are different expansion volumes.

3. The apparatus of claim 2, wherein the one or more expansion volumes is a balloon.

4. The apparatus of claim 3, wherein the balloon is configured to expand outside the vehicle hull.

5. The apparatus of claim 1, further comprising:
one or more energy cells;
one or more controllers; and
a cryo-hull;
where the one or more energy cells are configured to provide electrical energy to the vehicle;
wherein the one or more controllers are configured to accept a mission profile and maintain a self-preservation profile; and
wherein the cryo-hull is configured to store cryogen.

6. The apparatus of claim 5, wherein the cryo-hull is configured to jettison one or more panels.

7. The apparatus of claim 1, further comprising one or more ballast chambers;
wherein the one or more ballast chambers are configured to retain a ballast configured to be jettisoned.

8. The apparatus of claim 1, further comprising one or more pressure sensors;
wherein the one or more pressure sensors are configured to measure internal and external pressures of the vehicle.

9. The apparatus of claim 1, further comprising a relief valve, wherein the relief valve is configured to regulate internal gas pressure.

10. The apparatus of claim 1, wherein an internal pressure regulates the buoyancy within a fluid column pressure;
wherein internal pressure is controlled by a plurality of valves configured to release the cryogen gas;
wherein the cryogen gas expands and wherein the expanded cryogen gas increases the internal pressure of the vehicle;
wherein an increase in internal pressure of the vehicle increases buoyancy;
wherein the cryogen gas is released by the plurality of valves and wherein the release of the cryogen gas decreases the internal pressure;
wherein a decrease in internal pressure of the vehicle decreases buoyancy; and
wherein the vehicle buoyancy is neutrally maintained by the plurality of valves.

11. The apparatus of claim 1, further comprising a chemical gas generator, wherein the chemical gas generator produces a gas from a chemical reaction; and
wherein the chemical reaction is between a calcium disc and seawater.

12. A method for controlling the buoyancy of a trans-domain autonomous vehicle, the method comprising:
by a trans-domain autonomous vehicle within a fluid medium;
descending, by the trans-domain autonomous vehicle, through medium, where as a buoyant force acting on the trans-domain autonomous vehicle is less than a gravitational force acting on the trans-domain autonomous vehicle;
equalizing, by a gas, whereas the gas expands into one or more expansion volumes, whereas the expansion of the gas equalizes any difference between an external pressure and an internal pressure of the trans-domain autonomous vehicle;
neutralizing, by the gas into one or more expansion volumes, whereas the buoyant force acting on the trans-domain autonomous vehicle equals gravitational force acting on the trans-domain autonomous vehicle at a desired depth within the fluid medium; and
ascending, by a gas, whereas the gas expands into one or more expansion volumes; whereas the buoyant force acting on the trans-domain autonomous vehicle is greater than the gravitational force acting on the trans-domain autonomous vehicle within the fluid medium.

13. The method of claim 12, further including: reducing buoyance, by retaining one or more ballasts on the trans-domain autonomous vehicle.

14. The method of claim 12, further including: reducing a cryo-hull thickness, whereas the equalization of the internal pressure of the trans-domain autonomous vehicle to the external fluid medium strengthens a reduced thickness cryo-hull.

15. The method of claim 13, further including: fast ascension, by releasing the one or more ballasts retained by the trans-domain autonomous vehicle, whereas the release of the one or more ballasts increases buoyancy and rate of ascension.

16. The method of claim 12, further including: electrolysis boosting, by one or more electrolysis gas generators, by generating hydrogen and oxygen gas, whereas the hydrogen and oxygen gas expands into one or more expansion volumes.

17. The method of claim 16, whereas the one or more expansion volumes is one or more balloons.

18. A Seabed-To-Atmosphere Robot comprising:
an autonomous vehicle;
one or more expansion volumes;
a cryogen gas;
a chemical gas;
one or more energy cells;
one or more controllers; and
a cryo-hull;
where the one or more energy cells are configured to provide electrical energy to the autonomous vehicle;
wherein the one or more controllers are configured to accept a mission profile and maintain a self-preservation profile;
wherein the cryo-hull is configured to store cryogen;
wherein the autonomous vehicle is configured to submerge through a fluid column and ascend through a fluid and a gas column;
wherein the one or more expansion volumes is configured to accept the cryogen gas;
wherein the buoyancy of the autonomous vehicle within the fluid column is controlled by the cryogen gas;
wherein the one or more expansion volumes are configured to accept the chemical gas;
wherein the buoyancy of the autonomous vehicle within the gas column is controlled by the chemical gas;
wherein internal pressure is controlled by a plurality of valves configured to release the cryogen gas;
wherein the cryogen gas expands and where the expanded cryogen gas increases the internal pressure of the autonomous vehicle;
wherein an increase in internal pressure of the autonomous vehicle increases buoyancy;
wherein the cryogen gas is released by the plurality of valves and wherein the release of the cryogen gas decreases the internal pressure;
wherein a decrease in internal pressure of the autonomous vehicle decreases buoyancy; and
wherein the autonomous vehicle buoyancy is neutrally maintained by the plurality of valves.

19. The apparatus of claim 18, wherein the one or more expansion volumes for cryogen gas and the one or more expansion volumes for chemical gas are different expansion volumes.

20. The apparatus of claim 18, further comprising a chemical gas generator;
wherein the chemical gas generator produces hydrogen gas from a chemical reaction.
